(19) United States
(12) Patent Application Publication
(10) Pub. No.: US 2008/0033688 A1
(43) Pub. Date: Feb. 7, 2008

(54) MEASURING ANALYZER

(75) Inventors: Olaf SCHERMEIER, Lubeck (DE); Henning GERDER, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Drager Medical AG & Co., KG, Lubeck (DE)

(21) Appl. No.: 11/832,080

(22) Filed: Aug. 1, 2007

(30) Foreign Application Priority Data
Aug. 2, 2006 (DE) 10 2006 035 968.2

(51) Int. Cl. G01K 13/00; G06F 15/00

(52) U.S. Cl. 702/131; 702/127

(57) ABSTRACT

A measuring analyzer for analyzing physiological sensor data provided by sensors (4, 4′) with an analyzing unit (2), which generates measured data from the sensor data according to a mathematical relationship, with a display unit (3) for displaying the measured data, wherein an adaptation means (5) is provided, in which the sensor data are processed such that they are made available to the analyzing unit (2) in a form necessary for direct analysis.

### CROSS REFERENCE TO RELATED APPLICATIONS

This application claims the benefit of priority under 35 U.S.C. § 119 of German Patent Application DE 10 2006 035 968.2 filed Aug. 2, 2006, the entire contents of which are incorporated herein by reference.

### FIELD OF THE INVENTION

The present invention pertains to a measuring analyzer for analyzing physiological sensor data provided by sensors with an analyzing unit, which generates measured data from the sensor data according to a mathematical relationship, with a display unit for displaying the measured data.

### BACKGROUND OF THE INVENTION

A measuring analyzer for analyzing physiological sensor data provided by sensors is known from DE 41 03 801 C2. The core temperature and the peripheral temperature of a patient are calculated there as measured data in the measuring analyzer and displayed in a display unit. The sensors necessary for the measurement of the temperature are connected directly to the measuring analyzer.

A certain characteristic, by means of which the sensor data containing an electrical variable are converted into temperature values as measured data, is implemented in the measuring analyzer. The drawback of the prior-art measuring analyzer is that the analysis of the sensor data in the analyzing unit is in a fixed relationship with the sensors used. When sensors of another type or of another manufacturer are used, the function of the measuring analyzer is no longer ensured to the desired extent.

### SUMMARY OF THE INVENTION

The object of the present invention is therefore to further perfect a measuring analyzer for analyzing sensor data provided by sensors such that the use of an existing analyzing unit is also guaranteed for sensors of different types, but which are intended for the same measured variable, in a simple manner.

According to the invention, to accomplish this object, a measuring analyzer is provided for analyzing physiological sensor data. The measuring analyzer comprises a sensor for providing physiological sensor data and an analyzing unit for generating measured data from the sensor data having a form for direct analysis. The analyzing unit includes analyzing means for generating the measured data according to a mathematical relationship between sensor data having a form for direct analysis and measured data. The analyzing unit includes a display unit for displaying the measured data. An adaptation means is provided, in which the sensor data are processed such that the sensor data are made available to the analyzing unit in a form necessary for direct analysis.

The special advantage of the present invention is that by an additional adaptation means, an existing analyzing unit can be used to analyze sensor data of sensors of a different type. As a result, economical measurement analysis can be carried out, because it is possible to use an existing analyzing unit in case of detection by other sensors. The analyzing unit is preferably adapted to sensors that require the determination of the measured data on the basis of different characteristics.

According to a preferred embodiment of the present invention, the adaptation means according to the present invention makes it possible to provide the analysis unit with data for analysis in a standardized form. Sensor data of differently configured sensors can therefore be processed in the same analyzing unit with the same analysis parameters preset in the analyzing unit in a fixed manner.

The present invention advantageously makes it possible for an existing analyzing unit to be also able to be operated with novel sensors, where a distorted measurement result would be calculated if the sensors were directly coupled with the analyzing unit. The adaptation means according to the present invention thus makes possible the adaptation of the analyzing unit to a plurality of differently configured sensor units.

The adaptation means may be designed such that sensor data of different types of the sensors for the detection of measured data of the same kind are converted into analyzed data, which are made available as standardized variables to the analyzing unit and/or to the display unit.

The adaptation means may be designed such that sensor data of the sensors, which operate according to different characteristics, can be converted into measured data, which can be processed in the analyzing unit with the existing analyzing means.

The adaptation means may have on the one hand, a power supply unit for supplying the at least one sensor connected to an input of the adaptation means, and, on the other hand, a computing unit for calculating the measured data from the sensor data.

The computing unit of the adaptation means may advantageously comprise computing means, such that the voltage and/or current values representing sensor data are converted according to a characteristic into resistance values, which are made available as analysis data to the analyzing unit.

The computing unit of the adaptation means may be designed such that the sensor data are analyzed according to a calculation relationship and are made available to the display unit as measured data.

The display unit may be connected to an output of the adaptation means. The display unit may advantageously comprise at least one display screen.

The adaptation means may advantageously comprise a converting unit, in which the measured data calculated in the computing unit are simulated in a form that can be displayed on the output-side display unit.

The adaptation means may have a transmitting/receiving unit, which cooperates with a transmitting/receiving unit of a sensor unit for wireless communication between the adaptation means and the sensor unit.

The core temperature of a human may advantageously be calculated as the measured variable in the computing unit and/or the analyzing unit.

One additional sensor may be connected directly to the analyzing unit via the adaptation means. The additional sensor may especially be a temperature sensor for measuring the skin temperature.

The adaptation means may advantageously be designed as an electromechanical signal collecting distributor for additional medical sensors.

Exemplary embodiments of the present invention will be explained in more detail below on the basis of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a block diagram of a measuring analyzer according to a first embodiment;

FIG. 2 is a block diagram of a measuring analyzer according to a second embodiment;

FIG. 3 is a block diagram of a measuring analyzer according to a third embodiment; and

FIG. 4 is a block diagram of a measuring analyzer according to a forth embodiment.

### DESCRIPTION OF THE PREFERRED EMBODIMENTS

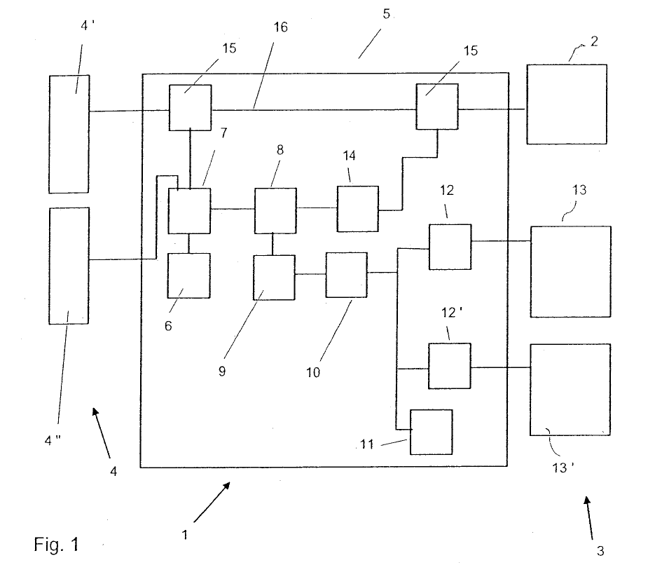

Referring to the drawings in particular, a measuring analyzer 1 according to FIG. 1 comprises essentially an analyzing unit 2, a display unit 3, a sensor unit 4 and an adaptation means 5.

The sensor unit 4 has a first temperature sensor 4′ for determining a skin temperature of a patient, which is accommodated in an incubator 2. Furthermore, the sensor unit 4 has a second temperature sensor 4″ for detecting an ambient temperature of the patient in the incubator 2. The sensor data detected by the temperature sensors 4′, 4″ are sent to the input of the adaptation means 5.

The adaptation means 5 completely splits the signal path between the sensor unit 4 and the analyzing unit 2.

The adaptation means 5 has, on the one hand, a power supply unit 6, by means of which, among other things, the sensors 4′, 4″ are supplied with electrical energy (current pulses).

Furthermore, the adaptation means 5 has a multiplexer 7, by means of which the sensor data 4′, 4″ are sent one after another to a voltage measuring unit 8, an A/D converter 9 and then to a computing unit 10. The desired core temperature values are calculated as measured data from the voltage analyzed data made available in the A/D converter 9 in the computing unit 10 according to a mathematical relationship (mathematical formula). These calculated measured data can then be displayed on a display 11 integrated in the adaptation means 5 and/or transmitted to different monitors (screens) 13, 13′, which are connected to the adaptation means 5. The transmission may directly contain the (digital) values calculated in the computing unit 10 via interfaces 12, 12′, but conversion may also be necessary in the interfaces 12, 12′ in order to convert the calculated values into resistance values for the case in which a temperature measuring input based on resistance measurement is to be used on the monitors 13, 13′.

Since the analyzing unit 2 is designed as an incubator here and it makes available only a resistance-measuring input in nearly all cases, a converting unit 14 with a converting circuit is provided, by means of which the voltage value taken from the sensors 4′, 4″ is converted into a resistance value, the conversion being based on the characteristic that is stored in the analyzing unit 2. This makes possible the simulation of the measured data, the analyzing unit 2 not being able to recognize the difference between a physically existing resistance value and the simulation.

This converting unit 14 is functionally equivalent to the interfaces 12, 12′ with integrated resistance conversion, always specially adapted to the different monitors 13, 13′ and the typical measuring inputs thereof, so that the display is based either on an actual, physically existing resistance value or on the simulation thereof. The monitors 13, 13′ cannot recognize the difference.

To make it possible to maintain the measurement by the analyzing unit 2 in case of failure of the power supply unit 6, two switch-over units 15 (relays), which make possible a direct connection between the analyzing unit 2 and the sensor unit 4 in case of error, are integrated in the adaptation means 5. The switch-over units 15 are arranged in a signal path 16 of the adaptation means 5, which makes possible a direct connection of the analyzing unit 2 to the sensor unit 4.

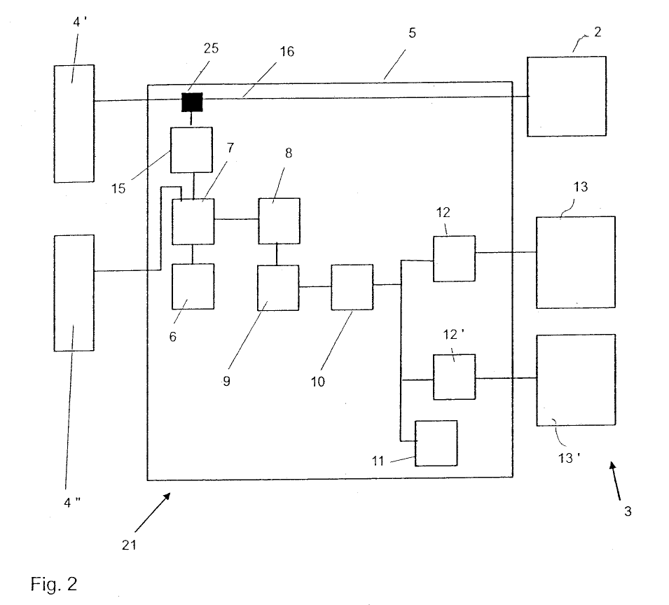

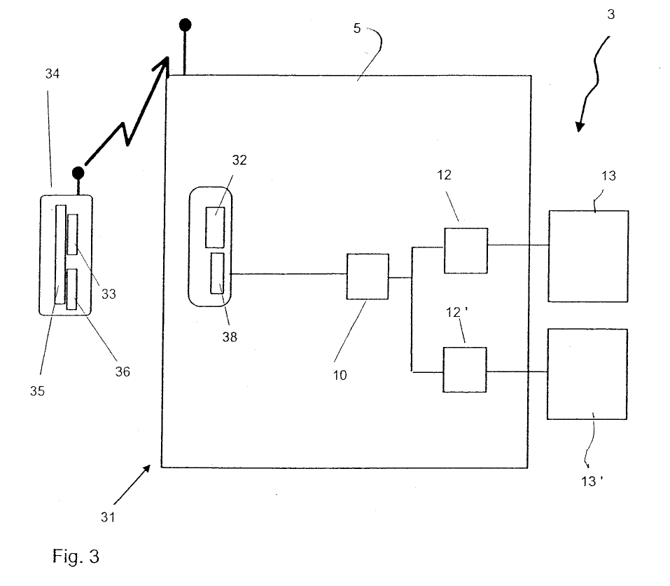

According to a second embodiment of a measuring analyzer 21 according to FIG. 2, complete separation of the voltage-measuring unit 8 from the signal path 16, which leads from the sensor unit 4 to the analyzing unit 2, takes place in case of error of the adaptation means 5. Identical components in the exemplary embodiments and identical component functions are designated by the same reference numbers, the components 12, 12′ corresponding here functionally to the converting unit 14 according to FIG. 1 and being hereinafter also called briefly simulation circuits for FIG. 3. A parallel voltage tap is designated by 25.

When the measuring analyzer 21 is used, the measured current of the incubator 2 is impressed in the sensors 4′, 4″ intermittently over time. The power supply unit 6 of the adaptation means 5 pulses during the pauses of the incubator 2 and measures the sensor voltage dropping now according to a high-resistance method.

The resistance simulation as a permanent loop takes place such that the resistance value that is preset as a set point by the computing unit 10 is set at first. Synchronization is then performed with the scanning characteristic of the incubator 2 or the display unit 3, and the feed current and the resistance value set are measured. The resistance value is adjusted after the variance comparison, and so on.

According to a third embodiment of a measuring analyzer 31, a signal path is not necessary between the sensor unit 4 and the incubator 2, because no analyzing means are contained in the incubator 2 according to this embodiment. The adaptation means 5 has a transmitting/receiving unit 32, which cooperates with a transmitting/receiving unit 33 of a sensor unit 34. The transmitting/receiving unit 32 has a corresponding circuit with a first microcontroller 38 for the data decoding. The decoded data then enter the computing unit 10, which provides the simulation circuits 12, 12′ with resistance set values.

A battery 35 as well as a second microcontroller 36 are implemented in the sensor unit 34, so that the adaptation means 5 can be placed, together with the display unit 3, at a desired site in a simple manner.

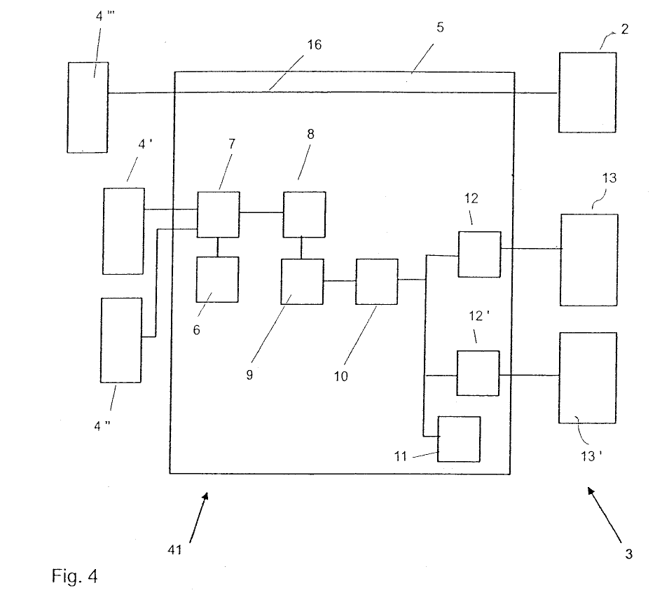

According to a forth embodiment of a measuring analyzer 41 according to FIG. 4, there is a complete separation of the voltage-measuring unit 8 from the signal path 16. This is similar to the second embodiment according to FIG. 2. However, in addition to sensors 4′ and 4″ at least one additional sensor 4′″ is provided. The sensor 4′″ is connected directly to the analyzing unit 2 via the signal path 16 of the adaptation means 5. In this embodiment the signal path 16 is direct and dedicated to the sensor 4′″ to the analyzing unit 2 connection. The additional sensor 4′″ is particularly a temperature sensor for measuring the skin temperature. This directly leads from the sensor unit 4′″ to the analyzing unit 2 through the adaptation means 5 (the signal path 16 of the adaptation means 5 provides a direct connection from sensor unit 4′″ to the analyzing unit 2). This is particularly useful in case of an error or problem with the adaptation means 5. Identical components in the exemplary embodiments and identical component functions are designated by the same reference numbers, the components 12, 12′ corresponding here functionally to the converting unit 14 according to FIG. 1 and being hereinafter also called briefly simulation circuits for FIG. 3.

While specific embodiments of the invention have been shown and described in detail to illustrate the application of the principles of the invention, it will be understood that the invention may be embodied otherwise without departing from such principles.

What is claimed is:

1. A measuring analyzer for analyzing physiological sensor data, the measuring analyzer comprising:
a sensor for providing physiological sensor data;
an analyzing unit for generating measured data from said sensor data having a form for direct analysis, said analyzing unit including analyzing means for generating said measured data according to a mathematical relationship between sensor data having a form for direct analysis and measured data, said analyzing unit including a display unit for displaying the measured data; and
an adaptation means for receiving said sensor data and processing said sensor data to provide sensor data having a form for direct analysis to said analyzing unit.

2. A measuring analyzer in accordance with claim 1, wherein said adaptation means includes conversion means for conversion of sensor data of different types of said sensor for the detection of measured data of the same kind into analyzed data, which are made available as standardized variables to said analyzing unit and/or to said display unit of said analyzing unit.

3. A measuring analyzer in accordance with claim 1, wherein said adaptation means includes conversion means for converting sensor data of said sensor, which operate according to different characteristics, into measured data, which can be processed in said analyzing unit with said analyzing means.

4. A measuring analyzer in accordance with claim 1, wherein said adaptation means comprises: an adaptation means sensor input; a power supply unit for supplying power to said sensor connected to said adaptation means sensor input; and a computing unit for calculating one of sensor data having a form for direct analysis from the sensor data and measured data from the sensor data.

5. A measuring analyzer in accordance with claim 4, wherein said computing unit of said adaptation means comprises computing means for converting voltage and/or current values representing sensor data into resistance values, which are made available as analysis data to said analyzing unit.

6. A measuring analyzer in accordance with claim 4, wherein said computing unit of said adaptation means produces measured data by analyzing and converting sensor data according to a calculation relationship to make converted sensor data available to said display unit as measured data.

7. A measuring analyzer in accordance with claim 1, wherein said display unit is connected to an output of said adaptation means and said display unit comprises at least one display screen.

8. A measuring analyzer in accordance with claim 4, wherein said adaptation means comprises a converting unit in which the measured data calculated in said computing unit are simulated in a form that can be displayed on an output side of said display unit.

9. A measuring analyzer in accordance with claim 1, wherein:
said sensor comprises a sensor unit with a transmitting/receiving unit; and
said adaptation means has a transmitting/receiving unit which cooperates with said transmitting/receiving unit of said sensor unit for wireless communication between said adaptation means and said sensor unit.

10. A measuring analyzer in accordance with claim 4, wherein a core temperature of a human is calculated as a measured variable in said computing unit and/or said analyzing unit.

11. A measuring analyzer in accordance with claim 1, further comprising an additional sensor connected directly to said analyzing unit via said adaptation means, said additional sensor being a temperature sensor for measuring the skin temperature.

12. A measuring analyzer in accordance with claim 1, wherein said adaptation means comprises an electromechanical signal collecting distributor for additional medical sensors.

13. A measuring analyzer system for analyzing physiological sensor data, the system comprising:
physiological sensors providing physiological sensor data in a sensor data format;
an analyzing unit for generating measured data from sensor data having a form for analysis based on a mathematical relationship, said analyzing unit including a display unit for displaying the measured data; and
an adaptation means for receiving said sensor data in a sensor data format and processing said sensor data in a sensor data format to provide to said analyzing unit sensor data having a form for analysis based on said mathematical relationship.

14. A measuring analyzer system in accordance with claim 13, wherein said adaptation means includes at least one of conversion means for conversion of sensor data of different types of said sensors for the detection of measured data of the same kind into analyzed data, which are made available as standardized variables to said analyzing unit and/or to said display unit of said analyzing unit and conversion means for converting sensor data of said sensors, which operate according to different characteristics, into measured data, which can be processed in said analyzing unit with said analyzing means.

15. A measuring analyzer system in accordance with claim 13, wherein said adaptation means comprises: an adaptation means sensor input; a power supply unit for supplying power to said sensor connected to said adaptation means sensor input; and a computing unit for calculating one of sensor data having a form for direct analysis from the sensor data and measured data from the sensor data.

16. A measuring analyzer system in accordance with claim 15, wherein said computing unit of said adaptation means comprises computing means for converting voltage and/or current values representing sensor data into resistance values, which are made available as analysis data to said analyzing unit.

17. A measuring analyzer system in accordance with claim 15, wherein said computing unit of said adaptation means produces measured data by analyzing and converting sensor data according to a calculation relationship to make converted sensor data available to said display unit as measured data.

18. A measuring analyzer system in accordance with claim 15, wherein said adaptation means comprises a converting unit in which the measured data calculated in said computing unit are simulated in a form that can be displayed on an output side of said display unit.

19. A measuring analyzer system in accordance with claim 15, wherein:
said sensor comprises a sensor unit with a transmitting/receiving unit; and
said adaptation means has a transmitting/receiving unit which cooperates with said transmitting/receiving unit of said sensor unit for wireless communication between said adaptation means and said sensor unit.

20. A measuring analyzer system in accordance with claim 13, further comprising an additional sensor connected directly to said analyzing unit via said adaptation means, said additional sensor being a temperature sensor for measuring the skin temperature.
